(19) United States
(12) Patent Application Publication
(10) Pub. No.: US 2018/0251710 A1
(43) Pub. Date: Sep. 6, 2018

(54) METHOD AND COMPOSITION FOR STABLE LIQUID TETRAACETYLETHYLENEDIAMINE COMPOSITION

(71) Applicant: Diversey, Inc., Charlotte, NC (US)

(72) Inventors: Niels Pijnenburg, Rosmalen (NL); Anant Parte, Charlotte, NC (US); Farida Tinwala, Mumbai (IN); Robert-Jan Uhlhorn, Tricht (NL)

(21) Appl. No.: 15/755,685

(22) PCT Filed: Aug. 30, 2016
(86) PCT No.: PCT/US2016/049444

§ 371 Date: Feb. 27, 2018

Related U.S. Application Data
(60) Provisional application No. 62/212,139, filed on Aug. 31, 2015.

(51) Int. Cl. C11D 3/39; C11D 3/395; C11D 3/37; C11D 3/20; C11D 3/33; C11D 3/36; C11D 11/00

(52) U.S. Cl. CPC C11D 3/3917; C11D 3/3947; C11D 3/3953; C11D 11/0017; C11D 3/2079; C11D 3/33; C11D 3/36; C11D 3/378

(57) ABSTRACT

The presently disclosed subject matter is directed to a stable liquid tetraacetylethylenediamine composition that can be used in hot and cold temperature washes. The disclosed liquid tetraacetylethylenediamine composition comprises tetraacetylethylenediamine, water, polymeric sulfonic acid, a buffer system and at least one additive. Also disclosed is a method for preparing a peroxide solution using a stable liquid tetraacetylethylenediamine composition and a peroxide and a method of using the peroxide solution.

### FIELD OF THE INVENTION

The presently disclosed subject matter relates generally to liquid compositions for bleaching products and methods of making and using the same to provide an alternative peroxide bleaching composition.

### BACKGROUND

Peracetic acid (PAA) is a well-known organic peroxide and one of the most used bleaches in fabric care, such as sodium hypochlorite and hydrogen peroxide. PAA is widely used because of its excellent cleaning and disinfection properties. PAA has a better environmental profile than sodium hypochlorite and has a higher activity than hydrogen peroxide.

However, there are severe drawbacks for the use of PAA in laundry, especially in the safety and handling aspects of it due to the highly corrosive and highly flammable properties of PAA. PAA has a low flash point of 40° C., which can result in a fire or explosion if the product is not stored properly. Additionally, PAA has a very distinct and strong vinegar smell that is not appealing to consumers.

It is possible to create PAA in situ, by reaction of the weaker bleach, hydrogen peroxide (or derivatives like sodium percarbonate, sodium perborate, and other similar oxygen carrying derivatives), and a bleach activator. For example, PAA could be created in a washer after reacting hydrogen peroxide with tetraacetylethylenediamine (TAED) as shown in the formula below:

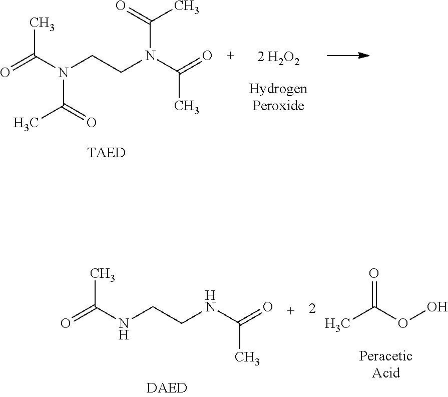

This reaction would create an inactive byproduct of diacetylethylenediamine (DAED). In this way, a much safer and completely odor-free system is created. Sodium percarbonate (2 Na₂CO₃.3H₂O₂), a solid carrier of hydrogen peroxide, can be prepared in a powder system with TAED. This system is well known as a preparation in one compartment as the two active components will not react with each other while they are both powders before entering the water phase of a washer. The water phase serves as the reaction medium for this reaction, which would happen immediately once the powder system was in contact with the water.

When TAED is converted into a liquid composition, it becomes incompatible with a peroxide if they are combined together. Therefore, when a liquid composition of TAED is created, peroxide is generally removed from it and it is dosed separately either in liquid or powder form. A powder form of TAED can be dispensed through a powder dispensing system, but liquid dispensing systems are more prevalent in industrial laundry facilities. A stable TAED composition in liquid form would be more advantageous for dosing and dispensing through automatic dispensing systems, which are primarily setup for liquid dispensing. Accordingly, there is a need in the art for a stable, liquid TAED composition that is compatible with a peroxide.

The presently disclosed matter is an improvement on the above compositions by offering a stable, liquid TAED composition that when used in combination with a peroxide gives similar cleaning and disinfection results as previous beach compositions.

### SUMMARY

The presently disclosed subject matter is directed to a liquid TAED composition of 15 wt % to 20 wt % tetraacetylethylenediamine, 75 wt % or less water, 0.5 wt % to 2 wt % polymeric sulfonic acid, 1 wt % to 4 wt % buffer system and 0.5 wt % to 3 wt % of at least one additive.

In some embodiments, the presently disclosed subject matter is directed to a method of preparing a peroxide solution. Particularly, the method comprises preparing a liquid TAED composition of 15 wt % to 20 wt % tetracetylethylenediamine, 75 wt % or less water, 0.5 wt % to 2 wt % polymeric sulfonic acid, 1 wt % to 4 wt % buffer system and 0.5 wt % to 3 wt % of at least one additive. The method further comprises contacting the liquid TAED composition and the bleaching compound. The liquid TAED composition is contacted with the bleaching compound in the presence of a reaction medium.

In some embodiments, the presently disclosed subject matter is directed to a method of treating a product. Particularly, the method comprises preparing a liquid TAED composition of 15 wt % to 20 wt % tetraacetylethylenediamine, 75 wt % or less water, 0.5 wt % to 2 wt % polymeric sulfonic acid, 1 wt % to 4 wt % buffer system and 0.5 wt % to 3 wt % of at least one additive. The liquid TAED composition is contacted with a bleaching compound to form a peroxide solution, where the liquid TAED composition is contacted with the bleaching compound in the presence of a reaction medium. A fabric is then treated with the peroxide solution by adding the peroxide solution to a container containing the fabric.

### BRIEF DESCRIPTION OF THE DRAWINGS

FIG. 1 is a bar graph that illustrates the relative percent of TAED in solution of the invention compared to competitor products at different temperatures and storage times.

FIG. 2 represents temperature dependent mass and energy changes of sample HC0715.

FIG. 3 represents temperature dependent mass and energy changes of sample TM0715.

FIG. 4 represents temperature dependent mass and energy changes of sample OB715.

### DETAILED DESCRIPTION

The presently disclosed subject matter is directed to a liquid TAED composition, methods of preparing a peroxide solution that has the liquid TAED composition and a bleaching compound. Also disclosed, are methods of treating a product using the peroxide solution mentioned above.

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a composition” includes a plurality of such compositions, and so forth.

Unless indicated otherwise, all numbers expressing quantities of components, reaction conditions, ingredients and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, and in some embodiments ±0.1%, from the specified amount, as such variations are appropriated in the disclosed package and methods.

As used herein, the term “compartment” refers to any section or part of a space, such as a container, that divides the space so that there are multiple separate spaces within the container.

As used herein, the term “composition” refers to any solution, compound, formulation or mixture with at least two ingredients. The ingredients may be, for example, chemicals, substances, molecules, or compositions.

As used herein, the term “additive” refers to any substance, chemical, or compound that is added to an initial substance, chemical, or compound in a smaller amount than the initial substance, chemical, or compound to provide additional properties or to change the properties of the initial substance, chemical, or compound.

As used herein, the term “bleaching compound” refers to any compound that removes color, whitens, sterilizes and/or disinfects a product. For example, a bleaching compound can be used in fabric care to remove color and disinfect a fabric or fabrics in a washer.

As used herein, the term “perfume” refers to any odoriferous material or any material which acts as a malodor counteractant. In general, such materials are characterized by a vapor pressure greater than atmospheric pressure at ambient temperatures. The perfume may also be referred to as a fragrance, odorant, essential oil, cologne, or eau de toilette.

As used herein, the term “preservative” refers to any chemical or compound that prevents degradation or breakdown of a compound or composition. A preservative also prevents bacteria from spoiling a compound or composition during storage or use.

As used herein, the term “buffer” refers to any chemical, compound, or solution that is used to control the pH of a composition, system, or solution. A “buffer system” refers to any composition or system where there are two or more components that are used to control the pH of a composition, system, or solution, such as an acid and a base. The components are any chemical, compound, or solution.

All compositional percentages used herein are presented on a “by weight” basis, unless designated otherwise.

Although the majority of the above definitions are substantially as understood by those of skill in the art, one or more of the above definitions can be defined hereinabove in a manner differing from the meaning as ordinarily understood by those of skill in the art, due to the particular description herein of the presently disclosed subject matter.

The presently disclosed composition is directed to a liquid TAED composition. The liquid TAED composition may have TAED, water, a dispersing agent, a buffer system and at least one additive. The dispersing agent may be polymeric sulfonic acid. In some embodiments, there may be a dual liquid system comprising a liquid TAED composition and a bleaching compound, where the liquid TAED composition is in a first compartment and a bleaching compound is in a second compartment. TAED is a bleach activator that is an active oxygen-releasing material to enhance the washing properties of a detergent. TAED provides bleaching at lower process temperatures and under milder pH conditions than other bleach activators.

The liquid TAED composition may include TAED. TAED may be supplied from various providers. The TAED may be a TAED product from the Mykon® Series from Warwick Chemicals. In some embodiments, the TAED may be Mykon® ATC 92% by Warwick Chemicals. In other embodiments, the TAED may be Mykon® cold wash by Warwick Chemicals. The TAED product may have additional ingredients in the product such as, for example, an organic binder and/or water. The Mykon® cold wash TAED product is modified from the standard TAED molecule to include an activator to allow for the TAED to work at lower temperatures than the standard TAED molecule.

The liquid TAED composition may have about 10 wt % to about 30 wt % TAED. In some embodiments, the liquid TAED composition may have about 15 wt % to about 20 wt % TAED. In further embodiments, the liquid TAED composition may have about 20 wt % TAED. The liquid TAED composition may have about 10 wt % TAED, about 11 wt % TAED, about 12 wt % TAED, about 13 wt % TAED, about 14 wt % TAED, about 15 wt % TAED, about 16 wt % TAED, about 17 wt % TAED, about 18 wt % TAED, about 19 wt % TAED, about 20 wt % TAED, about 21 wt % TAED, about 22 wt % TAED, about 23 wt % TAED, about 24 wt % TAED, about 25 wt % TAED, about 26 wt % TAED, about 27 wt % TAED, about 28 wt % TAED, about 29 wt % TAED, about 30 wt % TAED, or any range between any of these values. The TAED may be present as granules, pellets, or a powder. Additionally, the liquid TAED composition may have a purity of at least 90%, at least 91%, at least 92%, at least 93%, at least 94%, at least 95%, or any range between any of these values.

The liquid TAED composition may include water. The liquid TAED composition may have 75 wt % or less water. In some embodiments, the liquid TAED composition may have about 75 wt % water, about 74.5 wt % water, about 74.4 wt % water, 74.3 wt % water, 74 wt % water, 72 wt % water, 70 wt % water, 65 wt % water, 60 wt % water, 55 wt % water, 50 wt % water, 45 wt % water, 40 wt % water, 35 wt % water, 30 wt % water, 25 wt % water, 20 wt % water, 15 wt % water, 10 wt % water, 5 wt % water, 1 wt % water or any range between any of these values.

The liquid TAED composition may also have a dispersing agent. The dispersing agent may be used to help stabilize particles in a solution. A dispersing agent usually is non-active and may prevent settling or clumping of any particles in a solution. In some embodiments, the liquid TAED composition may have about 0.5 wt % of a dispersing agent, about 0.75 wt % of a dispersing agent, about 1.0 wt % of a dispersing agent, about 1.25 wt % of a dispersing agent, about 1.50 wt % of a dispersing agent, about 1.75 wt % of a dispersing agent, about 2.0 wt % of a dispersing agent, about 2.25 wt % of a dispersing agent, about 2.50 wt % of a dispersing agent, about 2.75 wt % of a dispersing agent, about 3.0 wt % of a dispersing agent, about 3.25 wt % of a dispersing agent, about 3.50 wt % of a dispersing agent, about 3.75 wt % of a dispersing agent, about 4.0 wt % of a dispersing agent, about 4.25 wt % of a dispersing agent, about 4.50 wt % of a dispersing agent, about 4.75 wt % of a dispersing agent, about 5.0 wt % of a dispersing agent, or any range between these values. In some embodiments, the dispersing agent may be a polymer, such as for example, polymeric sulfonic acid.

The liquid TAED composition may include polymeric sulfonic acid. The liquid TAED composition may have 0.5 wt % to 2 wt % polymeric sulfonic acid. In some embodiments, the liquid TAED composition may have about 0.5 wt % polymeric sulfonic acid, about 0.75 wt % polymeric sulfonic acid, about 1.0 wt % polymeric sulfonic acid, about 1.25 wt % polymeric sulfonic acid, about 1.50 wt % polymeric sulfonic acid, about 1.75 wt % polymeric sulfonic acid, about 2.0 wt % polymeric sulfonic acid, about 2.25 wt % polymeric sulfonic acid, about 2.50 wt % polymeric sulfonic acid, about 2.75 wt % polymeric sulfonic acid, about 3.0 wt % polymeric sulfonic acid, about 3.25 wt % polymeric sulfonic acid, about 3.50 wt % polymeric sulfonic acid, about 3.75 wt % polymeric sulfonic acid, about 4.0 wt % polymeric sulfonic acid, about 4.25 wt % polymeric sulfonic acid, about 4.50 wt % polymeric sulfonic acid, about 4.75 wt % polymeric sulfonic acid, about 5.0 wt % polymeric sulfonic acid, or any range between these values.

In some embodiments, the polymeric sulfonic acid may be neutralized and may be at least 90% purity. The polymeric sulfonic acid may be at least 91% purity, at least 92% purity, at least 93% purity, at least 94% purity, at least 95% purity, at least 96% purity, at least 97% purity, at least 98% purity, at least 99% purity, or any range between any of these values. In some 235 embodiments, the liquid TAED composition may have about 0.5 wt % to about 5 wt % polymeric sulfonic acid, about 0.5 wt % to about 2 wt % polymeric sulfonic acid, about 0.5 wt % to about 1 wt % polymeric sulfonic acid, or any range between any of these values. In certain embodiments, the liquid TAED composition may have about 1 wt % polymeric sulfonic acid.

The liquid TAED composition may also have a buffer system. The buffer system may have a weak acid and the salt of the weak acid or a weak base and the salt of the weak base. In some embodiments, the liquid TAED composition may have about 1 wt % to about 10 wt % of a buffer system, about 1 wt % to about 7 wt % of a buffer system, and about 1 wt % to about 4 wt % of a buffer system. In other embodiments, the liquid TAED composition may have about 1 wt % of a buffer system, about 2 wt % of a buffer system, about 3 wt % of a buffer system, about 4 wt % of a buffer system, about 5 wt % of a buffer system, about 6 wt % of a buffer system, about 7 wt % of a buffer system, about 8 wt % of a buffer system, about 9 wt % of a buffer system, about 10 wt % of a buffer system, or any range between any of these values. In some embodiments, the liquid TAED composition may have about 2.8 wt % of a buffer system.

In some embodiments, the buffer system may be an acetic acid buffer system. In some embodiments, sodium hydroxide and acetic acid are reactants that may be mixed to create the acetic acid buffer system. The buffer system may have about 2 wt % acetic acid and about 0.8 wt % sodium hydroxide as reactants. A reaction occurs in situ, wherein the sodium hydroxide and acetic acid may react to form an acetic acid buffer system of sodium acetate and water. In some embodiments, the reaction may result in excess acetic acid remaining in the final mixture of sodium acetate and water. In some embodiments, the buffer system is an acetic acid buffer system with acetic acid and sodium acetate. In other embodiments, the acetic acid buffer system may be citric acid and sodium citrate.

In some embodiments, the acetic acid may have a purity of at least about 50%, at least about 60%, at least about 70%, at least about 80%, at least about 90%, or any range between any of these values. The sodium hydroxide may have a purity of at least about 50%, at least about 60%, at least about 70%, at least about 80%, at least about 90%, or any range between any of these values.

The liquid TAED composition may have at least one additive. In some embodiments, the liquid TAED composition may have about 0.1 wt % to about 5 wt % of at least one additive, about 0.2 wt % to about 4 wt % of at least one additive, about 0.5 wt % to about 3 wt % of at least one additive or any range between any of these values. In other embodiments, the liquid TAED composition may have about 1.8 wt % of at least one additive. The additives may be at least one colorant, perfume, preservative, chelating agent or solvent.

The additive may be at least one colorant. In some embodiments, the colorant may be any pigment or dye well known in the art. For example, in some embodiments, the colorant may be color index vat blue 4, color index vat red 23, color index acid blue 299, color index acid blue 112 and combinations thereof.

The additive may also be at least one perfume. The perfume may provide an odor or fragrance that is appealable to a person or neutralize odors of a composition or of a product that may come in contact with the composition. The perfume may be any natural or synthetic perfume that is well known. For example, in some embodiments, the perfume may be a flower or herbal fragrance, such as rose extract, violet extract, and/or lavender extract; a fruit fragrance, such as lemon, lime, and/or orange; synthetic perfumes, such as musk ketone, musk xylol, aurantiol and/or ethyl vanillin. The perfume may be from a wide variety of chemicals, such as aldehydes, ketones, esters and the like.

The additive may be at least one preservative. In some embodiments, the preservative may be at least one glutaraldehyde, isothiazolinone, benzyalkonium chloride, polyaminopropyl biguanide, ethylenediaminetetraacetic acid (EDTA), triclosan, thimerosal, and combinations thereof. In some embodiments, the preservative may be 1,2-benzisothiazolin-3-one sodium salt. The preservative may be about 0.1 wt % of the liquid TAED composition, about 0.2 wt % of the liquid TAED composition, about 0.3 wt % of the liquid TAED composition, about 0.4 wt % of the liquid TAED composition, about 0.5 wt % of the liquid TAED composition, or any range between any of these values. In a preferred embodiment, the liquid TAED composition may have 0.1 wt % of 1,2-benzisothiazolin-3-one sodium salt.

The additive may also be at least one chelating agent. In some embodiments, the at least one chelating agent may be diethylene triamine pentaacetic acid, ethylenediaminetetraacetate, diethylene triamine penta(methylene phosphonic)acid, ethylene diamine tetra(methylene phosphonic) acid, ethylene diamine disuccinic acid, 1-hydroxyethane-1,1-diphosphonic acid, methylglycine diacetic acid, nitriloacetic acid, L-glutamic acid N,N-diacetic acid, tetrasodium salt, glutamic acid, N,N-diacetic acid sodium salt (GLDA-Na) and their salts. In a preferred embodiment, the chelating agents may be 1-hydroxyethane-1,1-diphosphonic acid and methylglycine diacetic acid trisodium salt.

The additive may also be at least one solvent. In some embodiments, the at least one solvent may be ethanol, propanediol, toluene, sulfonate, xylene sulfonate, and combinations thereof.

The liquid TAED composition may be in a dual liquid system. The liquid TAED composition may be present at about 10 wt % to about 30 wt % TAED in the dual liquid system, about 15 wt % to about 20 wt % TAED in the dual liquid system, about 20 wt % TAED in the dual liquid system, or any range between any of these values. In some embodiments, the liquid TAED composition may be present at about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, or any range between any of these values. The liquid TAED composition may be present as granules, pellets, or a powder. Additionally, the liquid TAED composition may have a purity of at least 90%, at least 91%, at least 92%, at least 93%, at least 94%, at least 95%, or any range between any of these values.

In some embodiments, the dual liquid system may have a reaction medium. The reaction medium may be a solvent, such as, for example, water. In some embodiments the water may be sterile water, deionized water, distilled water, soft water, chlorinated soft water, demineralized water, and combinations thereof. In some embodiments, the dual liquid system may have about 90 wt % of a reaction medium, about 89 wt % of a reaction medium, about 88 wt % of a reaction medium, about 87 wt % of a reaction medium, about 86 wt % of a reaction medium, about 85 wt % of a reaction medium, about 84 wt % of a reaction medium, about 83 wt % of a reaction medium, about 82 wt % of a reaction medium, about 81 wt % of a reaction medium, about 80 wt % of a reaction medium, about 79 wt % of a reaction medium, about 78 wt % of a reaction medium, about 77 wt % of a reaction medium, about 76 wt % of a reaction medium, 75 wt % of a reaction medium, about 74 wt % of a reaction medium, about 73 wt % of a reaction medium, about 72 wt % of a reaction medium, about 71 wt % of a reaction medium, about 70 wt % of a reaction medium, or any range between any of these values. In other embodiments, the dual liquid system may have about 75 wt % or less of a reaction medium. In further embodiments the dual liquid system may have about 74 wt % of a reaction medium. The reaction medium may be water.

The dual liquid system may also have a bleaching compound. In some embodiments, the bleaching compound may be hydrogen peroxide, sodium percarbonate, sodium perborate, and combinations thereof. In a preferred embodiment, the bleaching compound may be hydrogen peroxide. The bleaching compound may be about 1 wt % of the liquid TAED composition, about 5 wt % of the liquid TAED composition, about 10 wt % of the liquid TAED composition, about 15 wt % of the liquid TAED composition, about 20 wt % of the liquid TAED composition, about 25 wt % of the liquid TAED composition, about 30 wt % of the liquid TAED composition, about 35 wt % of the liquid TAED composition, about 40 wt % of the liquid TAED composition, about 45 wt % of the liquid TAED composition, about 50 wt % of the liquid TAED composition, or any range between any of these values.

In some embodiments, the dual liquid system may have multiple compartments. In some embodiments, the liquid TAED composition may not be in contact with the bleaching compound. In a preferred embodiment, the liquid TAED composition may be in a first compartment and the bleaching compound may be in a second compartment. The first and the second compartments may be connected to each other, but separated by a dividing wall or other barrier. The first and the second compartments may not be connected to each other. In further embodiments, the first and the second compartment may be separate components of a washer.

A peroxide solution may be prepared using the above disclosed liquid TAED composition. In some embodiments, a peroxide solution may be prepared using the above disclosed dual liquid system. In some embodiments, the liquid TAED composition may be in a first compartment and the bleaching compound may be in a second compartment. The liquid TAED composition may have about 15 wt % to about 20 wt % tetracetylethylenediamine, about 75 wt % or less water, about 0.5 to about 2 wt % polymeric sulfonic acid, about 1 wt % to about 4 wt % of a buffer system and about 0.5 wt % to about 3 wt % of at least one additive. In some embodiments, the at least one additive may be a preservative and at least one chelating agent. The preservative may be 1,2-benzisothiazolin-3-one sodium salt. The at least one chelating agent may be HEDP and MGDA trisodium salt. In some embodiments, the liquid TAED composition may come in contact with the bleaching compound to prepare a peroxide solution. The bleaching compound may be a peroxide. In some embodiments, the peroxide may be hydrogen peroxide. In further embodiments, the liquid TAED composition may come in contact with the hydrogen peroxide in the presence of a reaction medium. In some embodiments, the reaction medium may be water. The peroxide solution may be PAA.

In some embodiments, a method of treating a product may include preparing the liquid TAED composition described above. The method may also include contacting the liquid TAED composition with a bleaching compound to form a peroxide solution. In some embodiments, contacting the liquid TAED composition with the bleaching compound may be in the presence of a reaction medium. In other embodiments, contacting the liquid TAED composition with the bleaching compound may not be in the presence of a reaction medium.

The peroxide solution may be used to treat a product. In some embodiments, treating a product may include treating a fabric with the peroxide solution by adding the peroxide solution to a container containing the fabric. In other embodiments, the treating a product may include treating a plurality of fabrics with the peroxide solution by adding the peroxide solution in a container containing the plurality of fabrics. In further embodiments, the container may be a washer.

The liquid TAED composition may be used in a washer at various temperatures. Temperatures include cold, warm and hot temperatures. Cold temperatures for fabric washing may include temperatures of 30 degrees Celsius and below. Examples of cold temperatures for fabric washing may include ranges of about 15 degrees Celsius to 30 degrees Celsius, about 15 degrees Celsius to 30 degrees Celsius, about 20 degrees Celsius to 30 degrees Celsius, and about 25 degrees Celsius to about 30 degrees Celsius. Warm wash temperatures include temperatures of 40 degrees Celsius and below. Examples of warm temperatures for fabric washing may include ranges of about 20 degrees Celsius to 40 degrees Celsius, about 25 degrees Celsius to 40 degrees Celsius, about 30 degrees Celsius to 40 degrees Celsius. Hot wash temperatures may include temperatures of 90 degrees Celsius and below. Examples of hot temperatures for fabric washing may include ranges of about 40 degrees Celsius to 90 degrees Celsius, about 45 degrees Celsius to 90 degrees Celsius, about 50 degrees Celsius to 80 degrees Celsius, about 50 degrees Celsius to about 75 degrees Celsius, and about 55 degrees Celsius to about 75 degrees Celsius. Examples of cold, warm and hot temperatures may overlap in ranges of each category as these are only examples.

The liquid TAED composition may be used in a hot wash cycle when using a washer or other automatic ware washing machines. In one embodiment, the liquid TAED composition may have Mykon® ATC 92% by Warwick Chemicals or similar Mykon® series TAED as the TAED for use in warm or hot wash cycles. The liquid TAED composition may be used in a cold wash cycle when using a washer or other automatic ware washing machines. In another embodiment, the liquid TAED composition may have Mykon® cold wash as the TAED for use in cold wash cycles.

The presently disclosed liquid TAED compositions and dual liquid system may be used to produce a peroxide solution that can be effective against a wide variety of microorganisms, including (but not limited to) bacteria, fungi, spores, yeasts, molds, mildews, protozoans, viruses, and so forth, including lipophilic, non-lipophilic, enveloped and naked RNA/DNA types. Thus, the presently disclosed system, compositions and solutions are useful in reducing the microbial or viral populations on surfaces or objects, in liquids and gases, on the skin of humans and animals, on fabrics, and so forth. They are also useful in reducing odors. The disclosed systems, compositions and solutions may be utilized in cleaning and a wide variety of other applications relating to the food industry, hospitality industry, medical industry, and so forth.

The disclosed compositions and solutions may be contacted with soiled or cleaned fabrics using virtually any technique known to those in the art. For instance, the compositions and solutions may be sprayed onto a fabric, wiped onto a fabric, fabrics may be dipped into the aqueous solution, and/or the cleaning system, compositions and solutions may be used in automatic ware washing machines or other batch-type processing.

These applications are for illustrative purposes only and are not intended as a limitation on the scope of the presently disclosed subject matter. For example, in some embodiments, the disclosed system, compositions and solutions may be used to treat hard surfaces. Hard surfaces include those surfaces comprised of metal, glass, ceramic, natural and synthetic rock, wood, and/or polymeric surfaces found on exposed environmental surfaces such as tables, floors, walls, and other mobile surfaces such as dishware including pots, pans, knives, forks, spoons, plates, dishes, food preparation equipment such as tanks, vats, lines, pumps, hoses, and other processing equipment.

The presently disclosed subject matter provides a system and method for point-of-use generation of a peroxide solution. The presently disclosed liquid TAED composition offers a stable composition. The stable composition offers enhanced shelf stability.

The disclosed dual liquid system is a safe and easy-to-handle system that shows similar bleaching and disinfection properties as PAA itself, and the liquid TAED composition and bleaching compound are in separate compartments. Additionally, this reaction only takes place in a container and not in the dual liquid system itself resulting in a more stable liquid TAED composition.

Although several advantages of the disclosed system are set forth in detail herein, the list is by no means limiting. Particularly, one of ordinary skill in the art would recognize that there can be several advantages to the disclosed system and methods that are not included herein.

### EXAMPLES

The following Examples provide illustrative embodiments. In light of the present disclosure and the general level of skill in the art, those of ordinary skill in the art will appreciate that the following Examples are intended to be exemplary only and that numerous changes, modifications, and alterations can be employed without departing from the scope of the presently disclosed subject matter.

### Example 1

### Preparation of Liquid TAED Composition

A liquid TAED composition (Sample 1) was prepared according to the formulation in Table 1 below. The chelants MGDA and HEDP were used for calcium, magnesium, iron, and manganese chelation. The liquid TAED composition was physically and chemically stable.

TABLE 1
Liquid TAED Composition

| | Quantity |
|---|---|
| Description | (wt %) |
| Water (deionized) | 74.4 |
| 1,2-benzisothiazolin-3-one sodium salt (20%) | 0.1 |
| Tetraacetylethylenediamine (92%) (Mykon ® | 20 |
| ATC 92% by Warwick Chemicals) | |
| Acetic acid (60%) | 2 |
| Sodium hydroxide (50%) | 0.8 |
| 1-hydroxyethane-1,1-diphosphonic acid (60%) | 0.5 |
| Methylglycine diacetic acid trisodium salt (40%) | 1.2 |
| Polymeric sulfonic acid, neutralized (90%) | 1 |
| (Hostagel AV by Clariant) | |

The information for the ingredients including tradename, supplier and features of each are included in Table 2 below:

TABLE 2
Ingredient Details

| Ingredients | Supplier | Tradename | CAS # | Properties |
|---|---|---|---|---|
| Tetraacetyl- | Warwick | Mykon ® | 10543- | Density: 550 |
| ethylene- | Chemicals | ATC | 57-4 | kg/m3 |
| diamine | | | | |
| Tetraacetyl- | Warwick | Mykon ® | 10543- | Bulk Density: |
| ethylene- | Chemicals | Cold Wash | 57-4 | 430-580 |
| diamine | | | | kg/m3 |
| Polymeric | Clariant | Hostagel | | Viscosity: |
| sulfonic | | AV | | 40,000- |
| acid | | | | 60,000 mPas |
| Methylglycine | BASF | MGDA | 164462- | Density at |
| diacetic acid | | | 16-2 | 20deg C. for |
| trisodium salt | | | | 60% active - |
| | | | | 1.3 g/cm3 |
| 1-hydroxyethane- | Solay, | HEDP | 2809- | Specific |
| 1,1-diphosphonic | Aquapharm, | | 21-4 | gravity at |
| acid | FMC, Excel, | | | 20deg C. for |
| | Clariant | | | 60% active - |
| | | | | 1.45 |
| 1,2- | Clariant, | BIT | 2634- | Specifc |
| benzisothiazolin- | Dow, | | 33-5 | Gravity at |
| 3-one sodium salt | Lonza, Thor | | | 25deg C. for |
| | | | | 20% active - |
| | | | | 1.14 |

### Example 2

### Comparison of Liquid TAED Composition to Competitor Products

Sample 1 was compared to a competitor product (Sample 2) and to reference TAED products (Samples 3 and 4). The results are shown in Table 3 below. The initial TAED percentage was measured for all compositions, and then the TAED percentage was measured again at one and three month time periods during storage in 20° C. and 40° C. temperature conditions. An additional evaluation was done at a one month time period after storage in 50° C. temperature conditions.

TABLE 3
Comparison of Composition Stability
Compared to Competitor Products

| | | 20 deg C. | | 40 deg C. | | 50 deg C. |
|---|---|---|---|---|---|---|
| | Initial | 1 month | 3 months | 1 month | 3 months | 1 month |
| | % | % | % | % | % | % |
| Product | TAED | TAED | TAED | TAED | TAED | TAED |
| Sam- | 18.6 | 18.4 | 18.3 | 18.1 | 16.5 | 17.0 |
| ple 1 | | (99%) | (98%) | (97%) | (89%) | (91%) |
| Sam- | 16.9 | 15.9 | 14.7 | | | |
| ple 2 | | (94%) | (87%) | | | |
| Sam- | 10.9 | 10.4 | Physically | 9.5 | Physically | Physically |
| ple 3 | | (95%) | instable | (87%) | instable | instable |
| Sam- | 22.5 | 21 | | | | 14 |
| ple 4 | | (93%) | | | | (62%) |
| | | | | | | (4 weeks |
| | | | | | | at 45 |
| | | | | | | deg C.) |

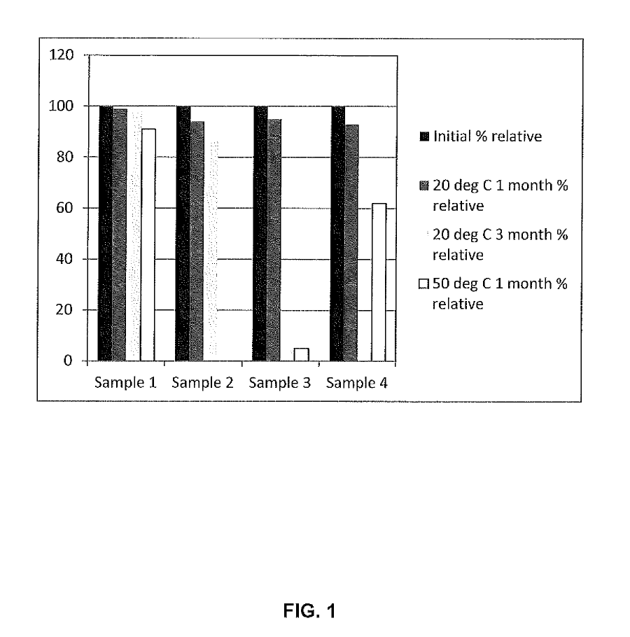

As illustrated in FIG. 1, it can be concluded that Sample 1 was physically stable at 20° C., 40° C., and 50° C. after one month and at 20° C. and 40° C. after three months. Sample 1 had a TAED relative percentage that was 99% of the initial TAED percentage after one month at 20° C., and 98% of the initial TAED percentage after three months at 20° C. Sample 1 had a TAED relative percentage that was 97% of the initial TAED percentage after one month at 40° C., and 89% of the initial TAED percentage after three months at 40° C. Even after one month at 50° C., Sample 1 was 91% of the initial TAED percentage. When evaluating the competitor product, Sample 2 had decreased to 94% of the initial TAED percentage after only one month at 20° C., and decreased to 87% of the initial TAED percentage after three months at 20° C. The reference TAED product, Sample 3, was physically instable after three months at 20° C. and 40° C. and after one month at 50° C. The second reference TAED product, Sample 4, only had 93% of the initial TAED percentage after one month at 20° C. and decreased to 62% of the initial TAED percentage after one month at 45° C. FIG. 1 graphically illustrates the relative % TAED in solution for the invention compared to competitor products at different temperatures and storage times. If there is no bar at the specific temperature and time point there were no data. The value of the physically instable samples was set to 5% to discriminate from missing data points.

### Example 3

### Differentiation of Composition to Competitor Product

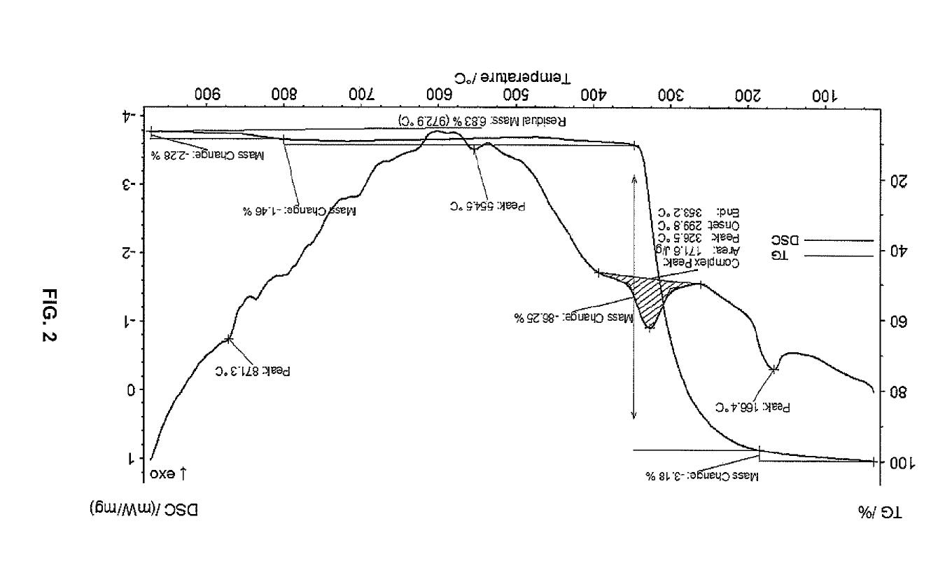

Sample OB0715 was compared to a competitor product (Sample HC0715) to differentiate the composition of the samples based on the presence of MGDA in the formula. The raw material MGDA (Sample TM0715) was also tested as a reference point. A simultaneous thermal analyzer (STA), NETZSCH model STA 449 F3 Jupiter®, was used to measure the mass loss and energy change with temperature for the samples tested. The STA had a system with a furnace capable of operation from 25° C. to 1550° C. and was vacuum tight. The STA also was capable of heating rates up to 50 K/min and had a balance with a digital resolution of 1 μg/digit. STA results for each sample were represented by a thermal gravimetric analysis (TGA) curve tracking mass loss starting at 100% TG on the left y-axis and a digital scanning calorimetry (DSC) heating trace having a thermodynamic peak for each mass loss step measured in mW/mg on the right y-axis in FIGS. 2-4. Samples HC0715, TM0715 and OB715 each had an initial mass of 5.722 g, 6.025 g and 5.435 g, respectively. The experimental setup used alumina crucibles, type S sample thermocouple, nitrogen (60 ml/min) purge gas, nitrogen (20 ml/min) protective gas, 30° C. to 1000° C. temperature program and a heating rate of 10K/min.

FIG. 2 depicts temperature dependent mass and energy changes of sample HC0715. The TGA curve shows four mass loss steps corresponding to 3.18%, 86.3%, 1.46%, 2.28% and the residual mass is 6.83% at 973° C. The first mass loss was due to evaporation of surface water and the second mass loss step was due to decomposition of the raw material TAED, the third and fourth decompositions are most likely due to decomposition of organic fillers present in the sample. Simultaneously, there were also corresponding endothermic peaks at the residual mass loss steps observed in the DSC curve at 166° C., 327° C., 555° C. and 872° C., respectively.

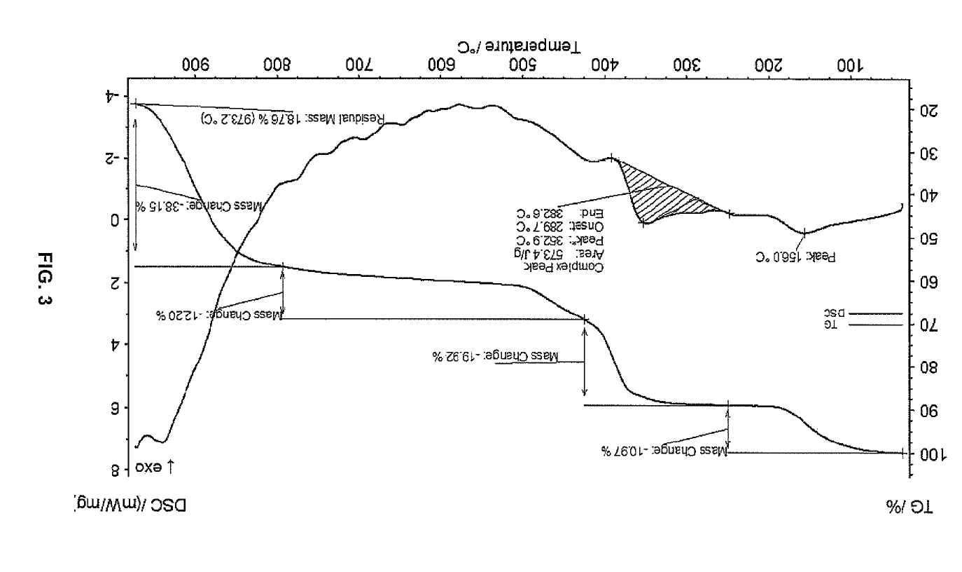

FIG. 3 depicts temperature dependent mass and energy changes of sample TM0715. Sample TM0715 is only the raw material, MGDA, and the TGA curve shows four mass loss steps corresponding to 11.0%, 19.9%, 12.2%, 38.2% and the residual mass is 18.8% at 973° C. The first mass loss was due to evaporation of surface water and the second, third and fourth mass loss steps are due to the decarboxylation steps of MGDA. Simultaneously, the corresponding endothermic peaks to the 11.0% and 19.9% mass loss were observed in the DSC curve at 156° C., 353° C.

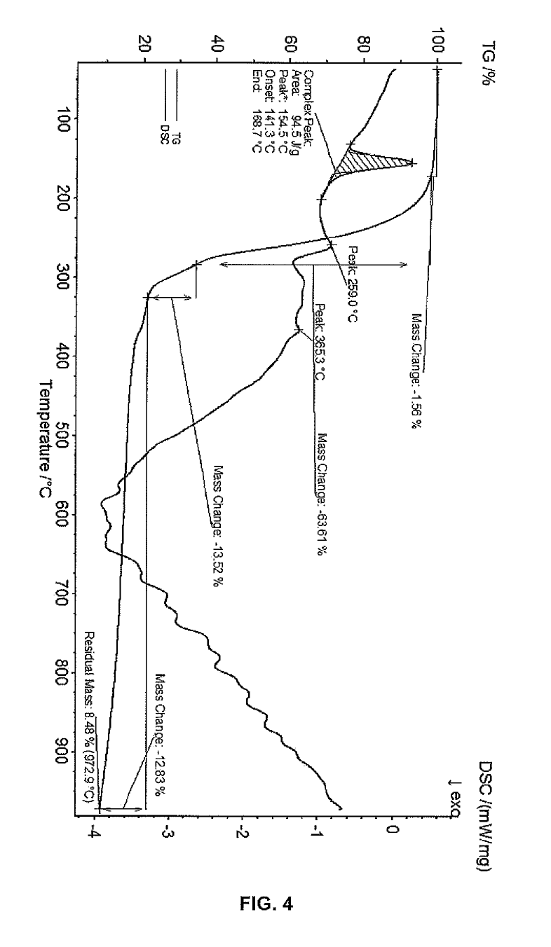

FIG. 4 depicts temperature dependent mass and energy changes of sample OB0715. The TGA curve shows five mass loss steps corresponding to 1.56%, 63.6%, 13.5%, 5.61%, 7.22% and the residual mass was 8.48% at 973° C. The first mass loss was due to evaporation of surface water and the second mass loss step was due to decomposition of the raw material TAED, the third, fourth and fifth decompositions are most likely due to decomposition of organic fillers present in the sample. Simultaneously, the corresponding endothermic peaks to the 1.56%, 63.6% and 13.5% mass loss were observed in the DSC curve at 155° C., 259° C., 365° C., respectively.

The results show that sample HC0715 has a second mass loss at 327° C., while samples OB0715 and TM0715 have a second mass loss observed at 155° C. and 156° C., respectively. As sample TM0715 is only MGDA, the onset of degradation (second mass loss) for sample OB0715 at a similar temperature is due to the presence of MGDA in sample OB0715. These results also identify that sample HC0715 does not have degradation at this temperature, concluding that sample HC0715 does not have MGDA in the composition.

What is claimed is:

1. A liquid tetraacetylethylenediamine composition comprising:
15 wt % to 20 wt % tetraacetylethylenediamine,
75 wt % or less water,
0.5 wt % to 2 wt % polymeric sulfonic acid,
1 wt % to 4 wt % of a buffer system, and
0.5 wt % to 3 wt % of at least one additive.

2. The liquid tetraacetylethylenediamine composition of claim 1, wherein the buffer system is an acetic acid buffer system comprising acetic acid and sodium acetate.

3. The liquid tetraacetylethylenediamine composition as in either claim 1 or 2, wherein the additive comprises at least one member selected from the group consisting of a colorant, perfume, preservative, chelating agent, and solvent.

4. The liquid tetraacetylethylenediamine composition of claim 3, wherein the preservative comprises at least one member selected from the group consisting of glutaraldehyde, isothiazolinone, benzyalkonium chloride, polyaminopropyl biguanide, ethylenediaminetetraacetic acid, triclosan and thimerosal.

5. The liquid tetraacetylethylenediamine composition of claim 3, wherein the chelating agent comprises at least one member selected from the group consisting of diethylene triamine pentaacetic acid, ethylenediaminetetraacetate, diethylene triamine penta(methylene phosphonic)acid, ethylene diamine tetra(methylene phosphonic) acid, ethylene diamine disuccinic acid, 1-hydroxyethane-1,1-diphosphonic acid, methylglycine diacetic acid, nitriloacetic acid, L-glutamic acid N,N-diacetic acid, tetrasodium salt, glutamic acid, N,N-diacetic acid sodium salt and their salts.

6. A method of preparing a peroxide solution, the method comprising:
preparing the liquid tetraacetylethylenediamine composition of claim 1; and
contacting the liquid tetraacetylethylenediamine composition and a bleaching compound;
wherein the liquid tetraacetylethylenediamine composition is contacted with the bleaching compound in the presence of a reaction medium.

7. The method of claim 6, wherein the bleaching compound is hydrogen peroxide.

8. The method of claim 6 or 7, wherein the buffer system is an acetic acid buffer system comprising acetic acid and sodium acetate.

9. The method as in any one of claims 6-8, wherein the additive comprises at least one member selected from the group consisting of a colorant, perfume, preservative, chelating agent and solvent.

10. The method of claim 9, wherein the preservative comprises at least one member selected from the group consisting of glutaraldehyde, isothiazolinone, benzyalkonium chloride, polyaminopropyl biguanide, ethylenediaminetetraacetic acid, triclosan and thimerosal.

11. The method of claim 9, wherein the chelating agent comprises at least one member selected from the group consisting of diethylene triamine pentaacetic acid, ethylenediaminetetraacetate, diethylene triamine penta(methylene phosphonic)acid, ethylene diamine tetra(methylene phosphonic) acid, ethylene diamine disuccinic acid, 1-hydroxyethane-1,1-diphosphonic acid, methylglycine diacetic acid, nitriloacetic acid, L-glutamic acid N,N-diacetic acid, tetrasodium salt, glutamic acid, N,N-diacetic acid sodium salt and their salts.

12. The method as in any one of claims 6-11, wherein the reaction medium is water.

13. A method of treating a product, the method comprising:
preparing the liquid tetraacetylethylenediamine composition of claim 1;
contacting the liquid tetraacetylethylenediamine composition of claim 1 and a bleaching compound to form a peroxide solution, wherein the liquid tetraacetylethylenediamine composition of claim 1 is contacted with the bleaching compound in the presence of a reaction medium; and
treating a fabric with the peroxide solution by adding the peroxide solution to a container containing the fabric.

14. The method of claim 13, wherein the bleaching compound is hydrogen peroxide.

15. The method of claim 13 or 14, wherein the buffer system is an acetic acid buffer system comprising acetic acid and sodium acetate.

16. The method as in any one of claims 13-15, wherein the additive comprises at least one member selected from the group consisting of a colorant, perfume, preservative, chelating agent and solvent.

17. The method of claim 16, wherein the preservative comprises at least one member selected from the group consisting of glutaraldehyde, isothiazolinone, benzyalkonium chloride, polyaminopropyl biguanide, ethylenediaminetetraacetic acid, triclosan and thimerosal.

18. The method of claim 16, wherein the chelating agent comprises at least one member selected from the group consisting of diethylene triamine pentaacetic acid, ethylenediaminetetraacetate, diethylene triamine penta(methylene phosphonic)acid, ethylene diamine tetra(methylene phosphonic) acid, ethylene diamine disuccinic acid, 1-hydroxyethane-1,1-diphosphonic acid, methylglycine diacetic acid, nitriloacetic acid, L-glutamic acid N,N-diacetic acid, tetrasodium salt, glutamic acid, N,N-diacetic acid sodium salt and their salts.

19. The method as in any one of claims 13-18, wherein the reaction medium is water.
